(19) United States
(12) Patent Application Publication
(10) Pub. No.: US 2005/0118338 A1
(43) Pub. Date: Jun. 2, 2005

(54) Control of the spatial distribution and sorting of micro-or nano-meter or molecular scale objects on patterned surfaces

(75) Inventors: Kathleen Joan Stebe, Baltimore, MD (US); Fengqui Fan, Baltimore, MD (US); Van Nguyen Truskett, Austin, TX (US)

Correspondence Address: EDWARDS & ANGELL, LLP, P.O. BOX 55874, BOSTON, MA, 02205, US

(73) Assignee: Johns Hopkins University, Baltimore, MD (US)

(21) Appl. No.: 10/838,655

(22) Filed: May 3, 2004

Related U.S. Application Data
(60) Provisional application No. 60/467,460, filed on May 2, 2003.

(51) Int. Cl. B05D 1/32

(52) U.S. Cl. 427/331; 427/282; 427/372.2

(57) ABSTRACT

A method of depositing and sorting micro-scale, nano-scale and molecular-scale objects onto a surface. In particular, the methods can be used to produce arrays of micro- and nanoscale objects on a surface by use of fluidic alignment with surface patterning techniques. In a preferred embodiment of the invention, the objects are sorted and/or spatially distributed and arrayed into micro- or nanometer scale geometries with periodicity on a larger area by evaporation (or other means of selective removal of solvent) of liquid containing molecular scale solutes, nanowires, metallic particles, polymeric particles, inorganic particles or composite particles formed from such materials or preferably, such particles may be sorted and deposited from suspensions by continuously creating and evaporating films of the suspension on patterned substrates.

The present application claims the benefit of U.S. provisional application No. 60/467,460 filed on May 2, 2003, incorporated herein by reference in its entirety.

### FIELD OF THE INVENTION

This invention relates to a method for depositing and/or sorting objects of interest onto a surface. In particular, the present methods are directed towards depositing microscale, nanoscale and molecular scale objects on a surface and products thereof. Such objects are deposited by means of placing a solvent containing the objects suspended therein on a patterned surface followed by selective removal of the suspending solvent (e.g. by fluid evaporation). In particular, the objects are sorted and deposited by means of creating lyophilic regions of differing dimensions on the surface. Objects of micoscale, nanoscale or molecular scale (in the order of angstroms) can be sorted by size and/or distributed by this method. Methods of the invention are particularly useful in fabrication of a wide range of devices including data storage devices, flat screen displays, optical devices and sensors. Further, methods of the invention can be used to sort and to create 2D arrays of biological materials, such as cells, DNA and protein.

### BACKGROUND OF THE INVENTION

The creation of micro and nanoscale features is of interest for a wide range of technologies including data storage devices, flat screen displays, and sensors. Using various surface-patterning techniques, patterned surfaces with the complex geometries can be created. However, direct control of the spatial distribution and arrays of micro- or nano-meter scale objects across large areas is very difficult.

The deposition of particles in patterns with periodic spatial variation in complex two- and three-dimensional structure have attracted a major interest because their potential applications, such as optics, electronics and biochip devices and sensors. A number of methods have been reported for preparing such structure, including electrostatically guided deposition of particles on patterned substrates (J. Aizenberg, P. V. Braun, P. Wilzius, Phys. Rev. Lett. 2000, 84, 2997; C. Kruger, U. J. Jonas, Colloid Interface Science 2002, 252, 331; U. Jonas, A. del Campo, C. Kruger, G. Glasser, D. Boos, Proc. Nat'l Acad. Sci. 2002, 99, 8; H. Zheng, I. L. Lee, M. Rubner, P. Hammond, Adv. Mater. 2002, 14(8), 569; H. Fudouzi, M. Kbayashi, N. Shinya, Adv. Mater. 2002, 14(22), 1649) flow-induced packing into cavities of controlled dimensions and shape (Y. Yin, Y. Xia, Adv. Mater. 2001, 13, 267; M. Mamak, N. Coombs, G. A. Ozin, J. Am. Chem. Soc. 2000, 122, 8932), gravity sedimentation, P. N. Pusey, W. Vanmegen, Nature 1986, 320, 340; H. Miguez, F. Meseguer, C. Lopez, A. Balanco. J. S. Moya, J. Requena, A. Mifsud, V. Formes, Adv. Mater. 1996, 10, 480), electrophoretic deposition (R. C. Hayward, D. A. Saville, I. A. Aksay, Nature 2000, 404, 56) and colloidal epitaxy (LB technique, Q. Guo, X. Teng, S. Rahman, H. Yang, J. Am. Chem. Soc. 2003, 125, 630). Evaporation also provides a means of collecting particles near three phase contact lines, and has been used as a means of particle self-assembly. Three phase contact lines with contact angles less than 90° are sites of rapid evaporation. Continuity demands that an outward flow be generated toward contact lines that are pinned. In the absence of surface tension driven instabilities, (V. X. Nguyen, K. J. Stebe, Phys. Rev. Lett. 2002, 88, 164501), the flow toward the contact line is dominant. The flow carries suspended particles with it, collecting them near the contact line. Evaporating capillary bridges drive the particles into ordered assemblies (R. D. Deegan, O. Bakajin, T. F. Dupont, G. Huber, S. R. Nagel, T. A. Witten, Nature 1997, 389, 827; R. D. Deegan, Phys. Rev. E 2000, 61, 475; S. Maenosono, C. D. Dushkin, S. Saita, Y. Yamaguchi, Langmuir 1999, 15, 957; J. Conway, H. Korns, M. Fisch, Langmuir 1997, 13, 426; K. Uno, K. Hayashi, T. Hayashi, K. Ito, and H. Kitano, Colloid Polym Sci 1998, 276, 810). Multilayer crystals on a plate have also been formed (E. Adachi, A. S. Dimitrov, Nagayama, K. Langmuir 1995, 11, 1057; N. D. Denkov, O. D. Velev, P. A. Kralchevsky, I. B. Ivanov, H. Yoshimura, Nature 1993, 361, 26; N. D. Denkov, O. D. Velev, P. A. Kralchevsky, I. B. Ivanov, H. Yoshimura, Langmuir 1992, 8, 3183. c) C. D. Dushkin, H. Yoshimura, K. Nagayama, Chem. Phys. Let. 1993, 204, 455). Similar mechanisms have been used to direct the deposition of DNA to form extended structures near three phase contact lines on microarrays (J. Jing, J. Reed, J. Huang, X. Hu, V. Clarke, J. Edington, D. Housman, T. S. Anantharaman, E. J. Huff, B. Mishra, B. Porter, A. Shenker, E. Wolfson, C. Hiort, R. Kantor, C. Aston, Proc. Nat'l Acad. Sci. U.S.A. 1998, 95, 8046). This idea has been extended to include evaporation on patterned surfaces, including a channel between two large drops (Y. Masuda, K. Tomimoto, K. Kuomoto, Langmuir 2003, 19, 5179), and surfaces with striped lyophilic and lyophobic domains (C-A. Fustin, G. Glasser, H. W. Speiss, U. Jonas, Adv. Mater. 2003, 15(12), 1025). As the evaporating liquid de-wets the lyophobic regions, particles were drawn with the host fluid to sit atop the lyophilic domains, where subsequent evaporation allowed colloidal crystals to form.

However, two challenges in nanotechnology are the creation of particle arrays of two or more (homogeneous or heterogenous) objects within a matrix and sorting of (homogeneous or heterogenous) objects. Patterns of colloidal particles have been formed on patterned surfaces ether in the presence of the magnetic fields (B. B. Yellen, G. Friedman, Adv. Mater. 2004, 16, 111) or by exploiting electrostrostatic interactions (H. Zheng, I. L. Lee, M. Rubner, P. Hammond, Adv. Mater. 2002, 14(8), 569). Current particle separation techniques include field-flow fractionation (FFF) (E. Chemela, R. Tijssen, M. T. Blorn, H. J. G. E. Gardeniers, A van den Berg, Anal. Chem. 2002, 74, 3470), and separating particles based on their magnetic properties. (O. Siiman, A. Burshteyn, J. A. Maples, J. K. Whitesell, Bioconjugate Chem. 2000, 11, 549; S. Relle, S. B. Grant, Langmuir 1998, 14, 2316). There is a growing need in industry and health sciences for means to sort or separate particulate material whose components may include various kinds of macromolecules including DNA and synthetic polymers and micron sized particles including biological cells, latices, environmental partices, industrial powders, crystallization products, abrasives, etc.

It would, thus, be desirable to provide improved methods for the deposition of microscale, nanoscale and molecular scale particles, and to sort microscale, nanoscale and molecular scale particles.

### SUMMARY OF THE INVENTION

The present invention provides methods for depositing and sorting microscale, nanoscale and molecular scale (in the order of angstroms) objects on a surface. The present methods can be used in a wide range of technologies such as data storage devices, flat screen displays, optical devices, sensors, microarrays, and biological cell sorting. The present invention further provides products formed using such methods.

In one embodiment, microscale, nanoscale and molecular scale objects are deposited and/or sorted onto a surface by utilizing a combination of fluidic alignment and surface patterning techniques. In particular, surface is modified to have a pattern formed thereon and fluidic alignment is performed to deposit and/or sort the objects onto the patterned surface.

In another embodiment, microscale, nanoscale and molecular scale objects are deposited and/or sorted onto a surface by forming a pattern on the surface, depositing a fluid suspension of the objects onto the patterned surface, and selectively removing the solvent in the fluid element, thereby depositing and/or sorting the objects onto the patterned surface.

In another embodiment, microscale, nanoscale and molecular scale objects are sorted by size onto a surface by forming a pattern with features of differing dimension on the surface, depositing a fluid suspension of the objects to be sorted by dimension onto the patterned surface, and selectively removing the solvent in the fluid element to deposit the objects and sort tem according to size onto the patterned surface.

In another embodiment, microscale, nanoscale and molecular scale objects are deposited and/or sorted onto a surface by obtaining the surface; creating a lyophilic pattern on the surface; depositing a fluidic suspension containing the microscale, nanoscale and/or molecular scale objects onto the surface; and allowing the solvent to be selectively removed thereby depositing and/or sorting the microscale, nanoscale and/or molecular scale objects onto the surface.

In another embodiment, microscale, nanoscale and molecular scale objects are deposited and/or sorted onto a surface by utilizing surfaces of patterned lyophilic and lyophobic regions to provide a template to deposit and/or sort the objects by selectively removing the solvent in the fluid element from a drop or a dip-coated thin film, or a continuously deposited and evaporated film.

The means for selective removal of the solvent/fluid element of the suspension can vary provided that it removes the solvent/fluid element and allows for deposition of the suspended objects onto the patterned surface. Such means can include, for example, evaporation of the fluid, providing a surface that will absorb or otherwise incorporate the fluid and allowing absorption or incorporation of the fluid and suctioning of the fluid. In the case of evaporation, the rate of evaporation can be controlled by varying humidity and temperature in the system. Further, rate of absorption and incorporation of the fluid into the surface can be appropriately controlled by proper selection of surface materials and/or suspending fluids. Such selection can be determined by one of skill in the art based on the desired rates. In one embodiment, the objects are suspended in a fluid selected from organic solvents, fluorocarbon oils and solutions thereof.

The microscale, nanoscale and molecular scale objects that may be deposited and/or sorted in accordance with the present methods are selected from any objects that are capable of suspension in a solvent or from any objects that may be modified to be capable of suspension in a solvent. For example, objects that are not capable of suspension in a solvent may be surface functionalized so that they are capable of suspension in a solvent. Surface functionalizing can also be accomplished by adding surfactants that adsorb or bind to the particle surface, or by adding dyes or biomolecules. Yet other methods for surface functionalizing include appending the object with chemical moieties to form new molecules capable of suspension in a solvent. In preferred embodiments, the microscale, nanoscale and molecular scale objects are selected from metallic materials, magnetic materials, inorganic materials, polymeric materials, biological materials, small molecules, solutes of molecular dimensions, and composite materials made therefrom. More particularly, the micro, nanoscale and molecular scale objects are selected from metal particles, metal wires, metal tubes, latexes, polymers, DNA, protein, cells, cell contents, vesicles, proteins, peptides, RNA, DNA, drugs and salts. The objects may be materials with arbitrary shape and roughness, materials with heterogeneous surfaces and compound materials of arbitrary shape.

The surface onto which the objects are deposited are not particularly limited provided that a lyophilic/lyophoblc pattern can be formed thereon. In some embodiments, the surface is made of a neutral, charged or lyophilic material. In particular, the surface is preferably fabricated of a material selected from metallic, polymeric, inorganic or organic materials. The surface may be planar or non-planar, flexible or non-flexible. Some exemplary materials useful in forming the surfaces include, but are not limited to gold, SiO2, chromium, silver, copper, cadmium, zinc, palladium, platinum, mercury, lead, iron, manganese, tungsten and paper.

In accordance with method of the present invention, a pattern is formed on the surface, and the object(s) are selectively deposited onto the patterns. The patterns preferably comprise lyophobic and lyophilic regions. In particular, a suspension of the objects is deposited onto the surface. The suspension accumulates in the lyophilic regions and pulls away from the lyophobic regions. The fluid component of the suspension is then selectively removed, thereby depositing/sorting the objects onto the patterned surface. In particular, objects having a diameter less than the height of the accumulated suspension in each lyophilic region are contained in the accumulated suspension and objects having a diameter greater than the height of the accumulated suspension are excluded from the accumulated suspension. As such, objects can be deposited onto the surface selectively based on size. Further, the height of the accumulated suspension(s) are determined by the receding contact angle of the suspension.

Methods of the present invention can be used to deposit a variety of different types and sizes of objects. These objects are microscale, nanoscale and molecular scale (i.e. in the order of angstroms). In a preferred embodiment, the objects have a diameter of less than about 10 microns, more preferably less than about 1 micron, more preferably less than about 0.5 micron, and more preferably less than about 0.04 microns.

Methods of the present invention can deposit and sort objects onto a surface in any geometry that can be created by surface patterning, thus providing broad applicability in a range of technologies. For example, in some embodiments, the objects are deposited and sorted into square rings and/or lines. In one exemplary embodiment, objects are 800 nm particles periodically deposited onto the surface in the form of high-resolution two-dimensional arrays with 1-7 particles per domain.

Methods of the present invention are further capable of depositing and sorting a mixture of different sized objects. Still further, the pattern or lyophilic region(s) on the surface can comprise patterns or regions of one or more sizes. In general, the objects are only capable of being deposited on regions or patterns that are larger than those objects and, thus, sorting of object deposition by size is easily accomplished.

The present invention methods can be used for forming two-dimensional arrays of micro and/or nanoscale objects, arrays for biosensors and microphotonics products. Still further, methods of the present invention can be used for biomolecuar separation and distribution of particles with different DNA sequence and for separation and distribution of biological cells with different diameters.

Other aspects and embodiments of the invention are discussed below.

### DESCRIPTION OF THE DRAWINGS

FIG. 1 shows an example of a procedure to make a patterned surface using a PDMS stamp.

FIGS. 2a-f show a schematic concept of separating mixed particles with different size by using patterned lyophilic/lyophobic surfaces.

FIGS. 3a-e show optical microscopy images of (a) particle deposition on alternating lyophilic/lyophobic stripes of width 1 μm after the solvent (water) had evaporated, (b) 800 nm particles deposit on region A, (c) 800 nm particles deposit on the edge of region B and (d) 200 nm particles form an array on pattern, region C, (e) an SEM image of pattern formed by 200 nm particles in region C.

FIGS. 4a-d show (a) an optical micrograph of residue formed after evaporating a suspension of mixtures of 800 nm and 200 nm particles on a surface with alternating lyophilic/lyophobic stripes of width 5 μm, (b) SEM image of particles deposited in array corresponding to conditions in a, (c) an optical micrograph of residue formed after evaporating a suspension of mixtures of 800 nm and 200 nm particles on a surface with alternating lyophilic/lyophobic stripes of width 1 μm. Only the 200 nm microspheres have deposited on the patterned surface. (d) an SEM image of particles deposited in array corresponding to conditions in a corresponding to conditions in c.

FIGS. 5a-b show (a) residue formed after evaporating a suspension of mixtures of 800 nm and 2 μm particles on a surface with 2 sizes of lyophobic squares: 5 μm and 25 μm. Only the 800 nm particles deposit in the 5 μm squares; mixtures of both the particles deposit in the 25 μm squares. (b) an overlay fluorescence image obtained by exciting fluorescently-labeled biotin bound to the streptavidin-labeled particles.

FIG. 6 shows a schematic illustration of a PDMS stamp.

FIG. 7 shows an optical image of the gold substrate after deposition of latex on 40 μm squares. The residue of particles form arrays of square and ring features.

FIG. 8 shows an optical image of the gold substrate after deposition of 20 nm gold particles on 40 μm squares. The residue of particles form arrays of square rings. Note that the width of line is less than 1 μm.

FIG. 9 shows an optical image of the gold substrate after deposition of (a) nanotubes, and (b) Ni magnetic nanowires on 40 μm squares. The residue forms an array with features of square rings.

FIG. 10 shows an optical image of the gold substrate after deposition of latex on 5 μm stripes (left image) and squares (right image). The residue of particles deposit with linear features or distribute on the surface with each lyophilic area containing only a few particles.

FIG. 11 shows the apparent contact angle of water at pH 2 on the surface with 50 μm lyophilic squares spaced 50 μm apart on a continuous lyophobic substrate.

FIGS. 12a-b show (a) optical micrographs of the contact line of a droplet of water (dark region on the right) at pH 2 on a patterned substrate with 50 μm lyophilic squares spaced 50 μm apart on a continuous lyophobic surface. The corrugated edge of the drop is created by the flow into the lyophilic patches, out of the lyophobic domains. (b) A schematic of the formation of discrete fluid elements in the lyophilic patches. After the lyophilic feature fills with liquid, the contact line jumps backward to the next feature in the direction of the receding drop.

FIGS. 13a-e show colloidal particles assembled on 50 μm carboxylic acid terminated square patterned surfaces on a continuous methyl terminated surface at pH 2, 24.5° C., 21% humidity. (a) An optical micrograph of 0.8 μm amidine functionalized microspheres deposited at 0.1% volume fraction. (b) SEM image. (c) An optical micrograph of 0.8 μm microspheres deposited at 0.01% volume fraction. (d) Corresponding SEM image. (e) An optical micrograph of 10 Imsulfate-functionalized microspheres deposited at 0.07% volume fraction.

FIG. 14 shows nanoparticles (40 nm Au particles) assembled on 50 μm carboxylic acid terminated square patterned surfaces on a continuous methyl terminated surface atpH5.8, 24.5° C., 21% humidity at (a) 0.01% volume fraction. An SEM image of a multilayered ordered structure (b) 0.0001% volume fraction suspension. An optical image of particles accumulated at the edge of the feature.

FIGS. 15a-e show 800 nm particles assembled on 5 μm carboxylic acid terminated square patterned surfaces on a continuous methyl terminated surface at pH 2, 24.5° C., 21% humidity at 0.01% volume fraction. (a) An optical micrograph of nearly zero-dimensional distribution of single particles on each feature. (b) Corresponding SEM image. (c) A histogram of particle distribution in (a). (d) SEM image of particle assembly deposited under apparently similar conditions. (e) Histogram of particle distribution in (d).

FIG. 16 shows An SEM image of 0.8 μm microspheres assembled on a surface patterned with alternating 5 μm carboxylic acid terminated stripes and 5 μm methyl terminated stripes at pH 2, 24.5° C., 21% humidity, and 0.01% volume fraction.

FIG. 17 shows a schematic illustration of the surface with patterned lyophilicity/lyophobicity used in a set of experiments.

FIG. 18 shows an optical image of the gold substrate after deposition of latex on 50 μm squares. The residue particles with 3D crystal arrays of square distribute to form pattern. Colloidal particles assembled on 50 μm carboxylic acid terminated square patterned surfaces on a continuous methyl-terminated surface at pH 2, 24.5° C., 21% humidity (a) An optical micrograph of 0.8 μm amidine functionalized microspheres deposited at 0.1% volume fraction (b) SEM image.

FIG. 19 shows the optical image of the gold substrate after deposition of latex on 50 μm squares. The residue particles with 2D crystal arrays of square distribute to form pattern. Colloidal particles assembled on 50 μm carboxylic acid terminated square patterned surfaces on a continuous methyl-terminated surface at pH 2, 24.5° C., 21% humidity (a) An optical micrograph of 0.8 μm amidine functionalized microspheres deposited at 0.01% volume fraction (b) SEM image.

FIG. 20 shows an optical micrograph of 10 μm sulfate-functionalized microspheres deposited at 0.07% volume fraction to form cluster structure.

FIG. 21 shows an optical image of the gold substrate after deposition of 0.0001% volume fraction suspension 20 nm gold particles on 50 μm squares. The residue particles form arrays of square rings. Note that the width of line is less than 1 μm.

FIG. 22 shows an Optical image of the gold substrate after deposition of (a) nanotubes, and (b) Ni magnetic nanowires on 50 μm squares. The residue forms an array with features of square rings.

FIG. 23 shows 800 nm particles assembled on 5 μm carboxylic acid terminated square patterned surfaces on a continuous methyl-terminated surface at pH 2, 24.5° C., 21% humidity at 0.01% volume fraction (a) An optical micrograph of early O-D distribution of single particles on each feature (b) corresponding SEM image.

FIG. 24 shows an SEM image of 0.8 μm microspheres assembled on a surface patterned with alternating 5 μm carboxylic acid terminated stripes and 5 μm methyl terminated stripes at pH 2, 24.5° C., 21% humidity, and 0.01% volume fraction, forming particle line.

FIG. 25 shows an optical image of the substrate after deposition of protein on 50 μm squares. The residue forms an array with features of square rings.

FIG. 26 shows a fluoroscence microscopy image of the substrate after deposition of lamda DNA. (a) The residue DNA form arrays of spot on pattern surface with 5 μm squares. (b) The residue DNA form arrays of stretch on 50 μm squares.

FIG. 27 shows Optical microscopy image of the substrate after deposition of 1% glycine solution in water on 25 μm squares to form micrometer size crystal arraying on surface.

FIG. 28 shows an SEM image of the substrate with alternating lyophilic/lyophobic stripes of 5 μm (a) and alternating lyophilic/lyophobic stripes of 1 μm (b) after having dip coated a 1% mixed suspension of 200 nm and 800 nm particles at a speed of 2 μm/min by a continuous dip-coating process.

FIG. 29 shows an optical micrograph of mixed particle assemblies on a surface patterned with 5 μm lyophilic square and 25 μm lyophilic square regions.

FIG. 30 shows a fluorescence micrograph of mixed particle with different DNA sequences assembled on a surface patterned with 5 μm square and 25 μm square hydrophilic region to form a chip structure.

### DETAILED DESCRIPTION OF THE INVENTION

The present invention provides a method preferentially depositing and/or sorting microscale, nanoscale and molecular scale particles onto a surface. Such methods can be used to produce patterns of particles arrayed on surfaces with complex geometries useful in a range of technologies including data storage devices, flat screen displays, and sensors.

In particular, according to the present methods, a drop of liquid containing the object(s) to be deposited and/or sorted on the surface (e.g. particles, nanowires, nanotubes, biological materials, etc) is dropped onto a patterned lyophilic surface and evaporated, thereby resulting in preferential deposition and/or sorting of the object(s) over the lyophilic regions. The objects may be microscale, nanoscale and molecular scale objects. The objects are thereby spatially distributed and arrayed into micro- or nanoscale or molecular scale geometries with periodicity on the surface by combining fluidic alignment with surface patterning techniques. This technique provides a quick and simple method to create small features. Further, the simplicity of this technique allows for potential mass production of such features. The present methods further provide a means for distributing and sorting particles by size on patterned lyophilic surfaces.

The methods of the present invention can be used to deposit and/or sort objects that are about 10 microns or less. In preferred embodiments, the methods of the present invention can be used to deposit and/or sort objects that are about 8 microns or less, more preferably about 6 micron or less, more preferably about 4 micron or less, more preferably about 2 micron or less, more preferably about 1 micron or less, more preferably about 0.9 micron or less, more preferably about 0.8 micron or less, more preferably about 0.7 micron or less, more preferably about 0.6 micron or less, more preferably about 0.5 micron or less, more preferably about 0.4 micron or less, more preferably about 0.3 micron or less, more preferably about 0.2 micron or less, more preferably about 0.1 micron or less, more preferably about 0.05 micron or less, more preferably about 0.04, micron or less more preferably about 0.03, and more preferably about 0.02 micron or less.

Furthermore, small molecules (e.g. glycine, of angstom lengthscales) can also be deposited in patterns by the present methods. Further, the methods are capable of producing arrays of particles with high-resolution in one or two-dimensional arrays.

Depending on the particular application, it is possible to deposit single particles as well as many particles on a lyophilic patterned surface. In one embodiment, methods are used to array 20 nm nanoparticles, nanowires and 800 nm particles into square rings and lines or other geometries as dictated by the geometries of the lyophilic regions. Methods can further be used to periodically distribute 800 nm particles to high-resolution two-dimensional arrays with 1-7 particles per domain.

In general, the present methods utilize surfaces of patterned lyophilicity to provide templates to deposit object(s) by placing a solvent containing suspended object(s) onto a patterned surface and selectively removing the suspending solvent (e.g. by fluid evaporation) e.g. from an evaporating drop, or from a dip-coated thin film. As the contact line recedes, the liquid layer becomes discontinuous, pulling back rapidly from the lyophobic regions, and fling the lyophilic regions. The discontinuous fluid elements that form can contain small particles if the particle diameter is less than the height of the fluid feature. If the particles are larger than the feature height, they are excluded from the lyophilic patch, and are pulled backwards with the parent drop, or with the fluid from which the thin film is withdrawn. This provides a means of sorting particles rapidly and in a highly parallelizable fashion by simply patterning a surface with lyophilic sites of differing dimension, and depositing suspensions which contain particles of differing size. Small particles can be sequestered on the smallest patches, while mixtures of larger and smaller particles will deposit on the larger patches. This can be exploited in the sorting of biomolecules, particles and deposition of materials for assays on microarrays, sensors, and the creation of regions of colloidal crystals for exploitation in photonic devices.

More specifically, the present methods are carried out in accordance with the following general procedure. A substrate/surface onto which the particles are to be deposited is obtained. The surface is then modified so as to contain lyophilic region(s)/pattern(s). Methods for creating surfaces having patterned lyophilic regions (patterned “wetting”) are well known and any of these methods may be used in the practice of the present invention. Such methods include, for example, soft lithography (for example, as set forth in U.S. Pat. Nos. 5,512,131; 6,518,168; 6,413, 587), e-beam lithography (for example, as set forth in U.S. Pat. No. 6,033,587) and by use of chemical vapor deposition and masks (for example, as set forth in U.S. Pat. No. 6,518,168). Soft lithography techniques are described herein as an example for creating self assembled monolayers (SAMS) of alkane thiols on gold, silver or copper. Similar techniques can be used to create self assembled monolayers on other substrates (e.g. carboxylic acids on metal oxides, siloxanes on SIO2, cyanide-terminated surfactants on platinum, etc.) These molecules are chosen because they form covalent bonds between the surfactant and the substrate. Paper can be patterned with wet and non-wet regions by coating with surfactant-laden inks. Polymer films can be patterned by a variety of known processes. For example, spontaneous phase separation in polymers is being explored as a means of creating domains of differing surface energies, and ultimately differing lyophilicity. Thus, the methods of the present invention are not limited by the technique by which the lyophilic patterns are created on the surface as such techniques are well-known and any of those known techniques may be used.

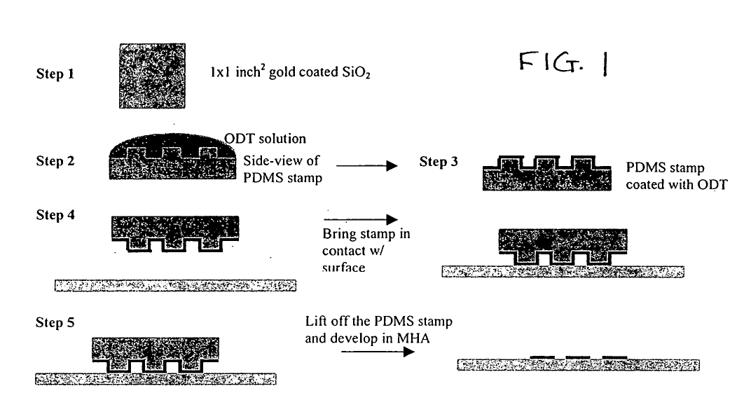

In one embodiment, for example, lyophilic surfaces are created by obtaining a surface onto which the object(s) are to be deposited and, preferably, cleaning and drying the surfaces as required, for example, by rinsing the surface with ethanol and air drying or blow drying with pure nitrogen gas. Surfactant molecules are then transferred in a desired pattern onto the surface. This can be done by use of a PDMS stamp. The fabrication and use of PDMS stamps is well known and, thus, the methods of the present invention are in accordance with such known methods. A PDMS stamp having the desired patterned face is obtained. The patterned face of the PDMS stamp is then coated with a solution so as to entirely cover the surface and is allowed to sit for a sufficient time, preferably at least one minute. The stamp can then be dried if desired, for example, using nitrogen gas. The solution is selected so as to contain a functional group that will bind to the surface material. Such materials can be readily determined by one of skill in the art. Preferably, when using a gold surface, the solution has at least one sulfur-containing functional group such as a thiols, sulfide, or disulfide as the interaction between gold and such sulfur-containing functional groups is well-known. In one preferred embodiment, the solution is an octadecanethiol (ODT) solution. However, the solution may be any solution provided that it leaves a pattern on the surface for a time sufficient for the solvent to be deposited and the fluid to evaporate and create fluidic elements. Preferably, the solvent bonds to the surface and creates lyophobic regions on the surface. In particular, in some embodiments, solvents that form covalent bonds with the surface are used so as to create a strong bond and pattern on the surface that will last. However, any solvent can be used even if it does not form a bond with the surface provided that it forms a pattern on the surface that does not get removed before the solvent forms fluidic elements and is selectively removed. The coated patterned face of the PDMS stamp is then placed onto the surface. Pressure can be applied to the PDMS stamp to provide more complete contact between the patterned face and the gold surface. After sufficient time to allow the functional group to bind to the surface the stamp is removed from the gold surface. The substrate is then transferred to a solution to functionalize noncontact areas (areas not contacted with the coated patterned face of the PDMS stamp). Such functionalizing solutions may vary depending on the surface material, the bound functional group, and the particles to be deposited. In general, the functionalizing solution is one that will provide lyophilic and lyophobic regions on the surface and such solutions could readily be determined by one of skill in the art. In one preferred embodiment, wherein the surface onto which the particles are deposited is gold and wherein the functional group contains sulfur (e.g. wherein ODT is the solution coated onto the PDMS stamp), the functionalizing solution is a 16-mercaptohexadecanoic acid (MHA) solution. The substrate is allowed to remain in the functionalizing solution for a time sufficient to allow for noncontact areas to be functionalized. The surface can then be rinsed to remove any residual materials, for example using ethanol, and the surface allowed to dry, for example via air drying or blow drying with nitrogen gas. A schematic of the above procedure is shown in FIG. 1.

At this point, the surface is functionalized with lyophilic regions (e.g. MHA) and with lyophobic regions (e.g. ODT). The objects/particles of interest (e.g. colloidal particles) are then deposited onto the surface. The substrate is preferably put into a chamber and the temperature and humidity adjusted as required. One or more suspension droplets, comprising a suspension of the particles for deposition in one or more fluids are then deposited onto the surface. The fluid can be selected from any fluid that will not adversely interfere with the properties of the surface or the suspended particles and which will allow for deposition of the particles onto the surface upon evaporation. In general, surfaces can be patterned to attract or be “well-wet” by any solvent in some regions (called lyophilic regions) and repel or be “poorly wet” by the solvent in other regions (called lyophobic regions). Examples include organic solvents, fluorocarbon oils, solutions of these solvents with molecules that dissolve in them, etc. One preferred fluid is distilled water. The fluid is then selectively removed, e.g. allowed to evaporate, thereby leaving particles deposited onto the surface. In the case of evaporation, the evaporation rate can be controlled by varying humidity and temperature in the system. The substrate is then allowed to dry, for example via air drying.

The above described process can be used on any substrate/surface materials with any types of objects to be deposited and sorted.

In general, the type of substrate and surface onto which the particles are to be deposited can vary depending on the application and desired properties of the end product. In general, the surface can be any metallic, polymeric, inorganic or organic surface. Further, the surface can be planar or non-planar. Still further, the surface can be flexible, inflexible or of varying degrees of flexibility. Some useful substrate materials may include, but are not limited to for example, gold, SiO2, chromium, silver, copper, cadmium, zinc, palladium, platinum, mercury, lead, iron, manganese, tungsten and paper. The substrate can be fabricated of a single material such that the surface onto which the particles are deposited is fabricated of the substrate material. Alternatively, the substrate can be coated on one or more surfaces with a suitable surface material, including all those set forth above, onto which the particles are to be deposited. Further, the dimensions of the substrate and coated layers, if present, can vary depending on the particular application. Such dimensions can be readily determined by one of skill in the art. The patterned length scale (e.g. side length of the square regions, thickness of the stripes), and the contact angle of the three phase contact line as the liquid recedes from covering the surface to filling only the lyophilic features determines the height of the fluid suspension in the lyophilic features, and therefore restricts the height of the particle that can be accommodated on that lyophilic feature. Thus, the critical film thickness, pattern length scale and particle deposition are related through these variables.

In an exemplary embodiment the substrate comprises an SiO2 wafer coated with a sublayer of chromium, coated with layer of gold film (e.g. a 100 nm gold layer).

Further, the types of particles/objects to be deposited onto the surface can vary depending on the application and desired properties of the end product. Some possible types of particles/objects may include, but are not limited to, particles, nanowires or nanotubes fabricated of a variety of materials (e.g. paramagnetic particles, ferromagnetic particles, metallic particles, conducting particles, nonconducting particles, semiconductor particles, composite material particles or nanowires, nanowires, nanotubes, polymer nanowires, polymeric spherical particles, particles of such materials of arbitrary shape and roughness), biological materials (e.g. DNA, protein, cells, RNA, peptide sequences, vesicles, cellular contents, antibodies, specific binding sites), small nonvolatile molecules that can be dissolved in solvents and deposited, including small molecule drugs, reagents, precursors for reactions, and particles that have been functionalized or appended to biological materials or small molecules.

In general, it is noted that the objects to be deposited can be any objects provided that they are capable of being suspended in a solvent or, alternatively, provided that they can be modified so as to be suspendable in solvent (for example, by surface functionalization of the particles, or by appending chemical moieties to form new molecules that can be solubilized). Thus, for example, materials with arbitrary shape and roughness, materials with heterogeneous surfaces, compound materials of arbirary shape, nanowires, cells, cell contents, vesicles, proteins, peptides, RNA, DNA, drugs, salts, etc. are all capable of deposition and sorting onto a surface in accordance with the presently described methods, provided they can be placed in a liquid or modified such that they can be placed in a liquid.

The deposition of the particles onto the patterned lyophilic surface will be discussed in more detail below.

It has been found that deposition of a solution containing a suspension of object(s) on surfaces of patterned lyophilicity, followed by selective removal of the fluid element of the solution, provides a consistent means of tailoring the geometry of particle distributions to create patterned media. Drops containing suspended particles are placed on surfaces of patterned lyophilicity created, for example, using soft lithography. The drop diameter is large compared to the dimensions of the patterns on the substrate. As the three-phase contact line of the drop recedes, spontaneous dewetting of the lyophobic domains and flow into the lyophilic domains to create discrete fluid elements with peripheries that can mimic the underlying surface topography. Suspended particles are carried with the fluid into the lyophilic regions and deposit there as the discrete fluid domains evaporate. If particle volume fractions are sufficiently high, the entire lyophilic domain can be covered with particles. At lower volume fractions, flow within the evaporating fluid element can direct the deposition of particles at the peripheries of the domains. High-resolution arrays of particles can be obtained with a variety of features depending upon the relative size of the lyophilic regions to the particles. When the lyophilic region is larger than the particles, three-dimensional and two-dimensional arrays of ordered particles mimicking the shape of the lyophilic pattern form, depending on the particle volume fraction. For lower volume fractions, one-dimensional (1-D) arrays along the lyophilic/lyophobic boundaries form. When the particle size is similar to the height of fluid on the lyophilic domain, zero-dimensional distributions of single particles centered in the lyophilic regions can form for lyophilic squares or 1-D distributions (stripes) form along the axis of striped domains. Depending on feature size, the diameter of the particles suspended in the fluids, and the volume fraction of the suspension, a variety of patterns form. When the lyophilic region is smaller than the particle size, the particles do not deposit within the features but are drawn backward with the receding drop.

The method for selectively removing the suspending solvent can vary and is not limited to fluid evaporation, as set forth in the detailed description and examples. For example, some other methods that may be used include depositing the suspension on a polymeric or paper substrate which swells to incorporate the solvent, or by removing the suspending solvent by suction. In any case, when sufficient solvent has been removed, the remaining fluid/suspension on the surface forms fluid elements that mimic the geometry of the underlying lyophilic features.

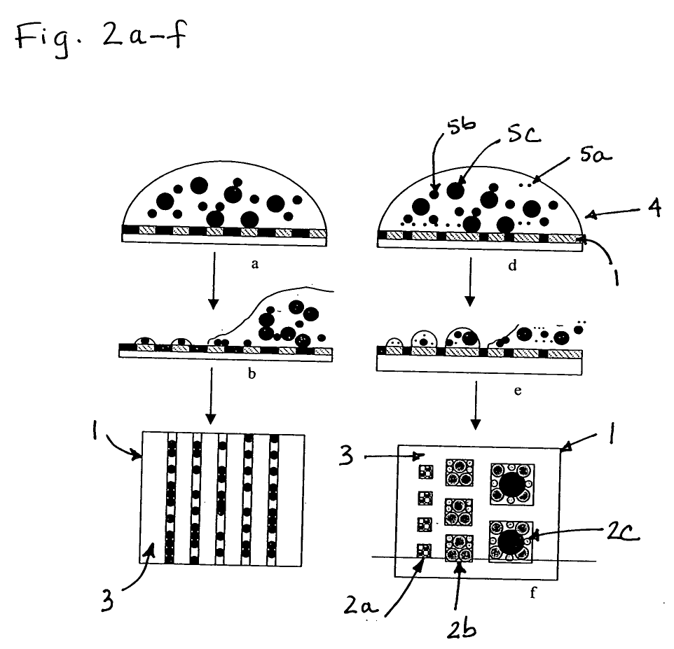

FIG. 2 illustrates this schematic concept of separating the mixed particles removed, the remaining fluid/suspension on the surface forms fluid elements that mimic the geometry of the underlying lyophilic features with different size by using patterned surfaces. When a drop is placed on substrates patterned, for example, with square lyophilic features, it first spreads, then evaporates with a receding contact line. As the contact line recedes, a local flow out of the lyophobic regions, and into the lyophilic regions fills the lyophilic features to create discrete fluid elements. As the drop recedes further, smaller droplets with particles, which look like a pattern, are left. Without being bound by theory, it is believed that the height of the fluid element formed is determined by the receding contact angle of the drop. If the height of the fluid element is larger than the diameter of the particle to be placed on it, particles can be accommodated in the fluid element and organized by the flow field within the element. If the particles are larger than the fluid element height, they are excluded from the fluid element, and are pulled backwards with the parent drop. Only the particles that are close to or smaller the pattern features are deposited on surfaces after solvents evaporate.

FIG. 2d-e presents a schematic of the procedure used to site-deposition of different size particles on different regions at the same time by evaporating a droplet on surfaces of patterned lyophilicity. A surface 1 is prepared so as to have a series lyophilic features 2a, 2b, 2c with different size surrounded by lyophobic matrix 3 (FIG. 2). This may be done by any known method such as, for example, microcontact printing. A drop 4 of mixed suspension containing different size particles 5a, 5b, 5c is placed on the surfaces of patterned lyophilicity 1 as shown in FIG. 2d. As an example, there may be three different sized lyophilic features—A, B and C, in order of smallest to largest size. Likewise, there may be three different sized particles a, b, and c, in order of smallest to largest size. Particle size a is less than or equal to feature size A, particle size b is less than or equal to feature size B and particle size c is less than or equal to feature size C. Of course, there can be any number of different sized lyophilic features in combination with any number of different sized particles. After the drop 4 is placed on the patterned surface 1, as the contact line recedes, the smallest droplets containing smallest particles 5a are left on the smallest lyophilic features 2a. Larger droplets containing medium sized particles 5b and/or smallest sized particles 5a are left on the medium sized lyophilic features 2b. The largest droplets containing large sized particles 5c, and/or particles 5b and/or particles 5a are left on the largest lyophilic features 2c. Droplets larger than the largest lyophilic features 2c are excluded and are pulled backwards with the parent drop. As the fluid element is selectively removed, e.g. by evaporation, the particles within the droplets 5a, 5b, 5c are deposited onto lyophilic features 2a, 2b, 2c. Thus, for example, if a droplet containing particles 2a is deposited on lyophilic feature 2a, upon selective removal of the solvent in the fluid element, e.g. by evaporation, the particles 5a are deposited on the lyophilic feature 2a. Likewise, if a droplet containing particles 5b and 5a is deposited on lyophilic feature 2b, upon selective removal of the solvent in the fluid element, e.g. by evaporation, the particles 5b and 5a are deposited on the lyophilic feature 2b. Similarly, if a droplet containing particles 5a, 5b and 5c is deposited on lyophilic feature 2c, upon selective removal of the solvent in the fluid element, e.g. by evaporation, the particles 5a, 5b and 5c are deposited on the lyophilic feature 2c, as shown in FIG. 2f.

By use of the present methods, particles of a certain size can be separated from a mixed suspension. This novel approach employs surfaces with a pattern of lyophilic and lyophobic regions as a media. By adjusting the size and lyophilicity of the patterned surface region, discrete fluid elements exhibit a high selectivity for particles with different sizes. The particles having a diameter that is larger than the height of fluid elements were excluded from the features, receding backwards with the parent drop. Using this method, particles can be site-deposited onto different regions on a surface with a series of designed patterns. Unlike previous methods, the present method is based on the alternation of lyophilic and lyophobic regions that permit the deposition of various particles, so long as they are lyophilic themselves, or can be functionalized or compounded with other materials to render them lyophilic—neutral, charged and lyophobic. Thus, particles can be functionalized, for example, by surfactants that adsorb or bind to the particle surface, or by dyes or biomolecules. As such, the present methods can be used in forming arrays for biosensors and in microphotonics. Further, the methods can be used in biomolecuar separation and distribution of particles with different DNA sequence.

It has been found that by making the dimensions of the lyophilic regions comparable to the particle size, and by controlling the deposition conditions (e.g. evaporation rate, concentration of suspension), the deposited objects are limited by the dimension of the lyophilic area, thus, creating desired patterns and assemblies.

In particular, it has been found that ordered arrays of particles can be created spontaneously by selective removal of the solvent in the fluid element, e.g. by evaporation of colloidal suspensions on surfaces of patterned lyophilicity from parent drops with diameters large compared to the length scale of the underlying pattern. For particles with diameters far smaller than the feature length scale, a variety of patterns were realized depending upon the volume fraction. At high volume fractions, particles pack to form ordered colloidal crystal multilayers. As volume fraction was reduced, ordered sparse monolayers and “coffee rings” decorating the edges of the features were created. The apparent receding contact angle of the drop can be related to the height of liquid in each fluid element. This determines the upper bound on the diameter of the particles that can be deposited on each feature. Thus, particles above a certain diameter are excluded from the features, receding backward with the parent drop. Under certain conditions, particles can form zero-dimensional arrays of a single particle per feature on lyophilic squares or one-dimensional stripes on lyophilic stripes. As such, surfaces of patterned lyophilicity provide a highly parallelizable means of tailoring the geometry of particle distributions to create patterned media. Further, any particle can be deposited by this technique, provided that it is lyophilic, or can so be rendered lyophilic by surface functionalization or compounding other materials that are lyophilic.

The present methods can further be advantageously used to distribute and array nanoscale objects on the nanoscale. The ability to creature such small features would be of interest to a wide range of devices including data storage devices, flat screen displays and sensors. The present methods can further be used to create 2D arrays of biological materials (i.e. DNA, Protein).

The methods of the present invention will be further illustrated with reference to the following Examples which are intended to aid in the understanding of the present invention, but which are not to be construed as a limitation thereof.

### EXAMPLE 1

Materials:

PDMS stamp with a pattern (e.g. stripes or square grids), 1 mM solution of octadecanethiol (ODT) and 16-mercaptohexadecanoic acid (MHA) in ethanol, gold coated surface, polystyrene latex, Au nanoparticle solution (0.001% in water with a diameter of 20 nm), Nanowires, distilled water, ethanol.

Procedure:

The first step is to transfer the surfactant molecules in a pattern onto the gold surface. A schematic of this procedure is shown in FIG. 1:
1. A gold surface was obtained (e.g. 100 nm gold film coated on sublayer of chromium on a SiO2 wafer) and cut a 1 inch square portion. The surface was rinsed with ethanol and blow dried with pure nitrogen gas.
2. A PDMS stamp was obtained having the desired pattern. FIG. 6 shows a schematic illustration of the PDMS stamp used in this set of experiments.
3. The PDMS stamp was positioned with the patterned features facing upwards. The patterned face of the stamp was coated with sufficient ODT solution to entirely cover the surface. The stamp and solution were allowed to sit for 1 min.
4. The stamp was blow dried with nitrogen gas.
5. The stamp was carefully placed with the coated patterned features face-down onto the gold surface. Sufficient pressure was applied to allow complete contact of the patterned stamp surface to the gold surface.
6. After 15 sec, the stamp was lifted off of the gold surface and the surface/substrate transferred to MHA solution for 1 hour to functionalize noncontact areas.
7. The gold surface was rinsed with ethanol to remove any residual surfactant and blow dried with nitrogen gas.

At this point, the gold surface is functionalized with lyophilic regions (MHA) and with lyophobic regions (ODT). The next step is to deposit the objects of interest (e.g. colloidal particles) onto the surfaces:
1. The substrate was put into a chamber and the temperature and humidity was adjusted as required.
2. The deposited drop volume fraction of suspended particles in distilled water with pH values of 2, 5 or 10 ranged from 1% to 0.001% for 0.8 μm particles and 0.01% to 0.0001% for 0.2 μm particles. All evaporations were performed at definite relative humidity (20%) and temperature (25° C.). The evaporation rate was controlled by varying humidity and temperature in the system. A know volume of suspension droplet was deposited on the patterned surfaces.
3. The sample was allowed to dry in air.

In the case in which gold nanoparticles was the desired deposited material, a 0.001% by volume of 20 nm gold particles, suspended in water, was used instead of the polystyrene latex and the same procedure described above was followed.

In the case of nanowires (e.g. nanotube, Ni nanowire), a 0.001% by volume of 100 nm in diameter by 3 μm in length of wires was used instead of the polystyrene latex and the same procedure described above was followed.

Results:

FIG. 7 shows the optical image of the gold substrate after deposition of latex on 40 μm squares. As shown, the residue particles form arrays of square and ring features. FIG. 8 shows the optical image of the gold substrate after deposition of 20 nm gold particles on 40 μm squares. As shown, the residue particles form arrays of square rings. It is noted that the width of the line is less than 1 μm. FIG. 9 shows the optical image of the gold substrate after deposition of (A) nanotubes and (B) Ni magnetic nanowires on 40 μm squares. As shown, the residue forms arrays with features of square rings.

As demonstrated in FIGS. 7-9, micro- or nano-meter scale objects deposited over the wetting regions (lyophilic regions). Thus, the latex, gold nanoparticles, nanowires and nanotubes are spatially distributed and arrayed into micro- or nano-meter scale geometries with periodicity on the larger areas by combining fluid alignment with surface patterning techniques.

It was also demonstrated that by making the dimensions of the wetting area region (lyophilic regions) comparable to the particle size, and by controlling the deposition conditions (e.g. evaporation rate, concentration of suspension), the deposited objects are limited by the dimension of the wetting area (lyophilic region), thus, creating desired patterns and assemblies, as shown in FIG. 10.

### EXAMPLE 2

Materials:

Substrates or thin films with patterned lyophilic surfaces formed by photolithography, soft lithography or other method, polystyrene latex, Au nanoparticle solution (0.001% in water with a diameter of 20 nm), Nanowires, Lamda DNA, Protein, polymer, distilled water.

Procedure:

The first step was to form lyophilic patterns on substrates such as silicon wafer, metal and polymer films by photolithography, e-beam lithography and soft lithography. Such methods are discussed herein, e.g. in Example 2, and can be in accordance with known methods.

The next step was to deposit the objects of interest (e.g. colloidal particles) onto the surfaces with lyophilic patterns by drop evaporating and dip coating. Drop evaporating was accomplished as follows:
1. The substrate was put into a chamber and the temperature and humidity was adjusted as required.
2. The deposited drop volume fraction of objects in solvents ranged from 10% to 0.00001%. All evaporations were performed at definite relative humidity (20%) and temperature (25° C.). The evaporation rate is controlled by varying humidity and temperature in the system. A know volume of suspension droplet was deposited on the patterned surfaces.
3. The sample was allowed to air dry.

This method was generally used for nanowires (e.g. nanotube, Ni nanowire), DNA and protein arrays.

Dip coating was accomplished as follows:

1. The substrate was fixed on a dip-coating equipment that slowly takes the substrate out from suspension and solution.
2. The substrates were put into the suspension or solution.
3. Substrates were lifted from the suspension or solution at a speed ranging from 0.1-50 μm/min.
4. The sample was allowed to air dry.

This method was generally used for depositing particles, polymers and organic compounds.

Results

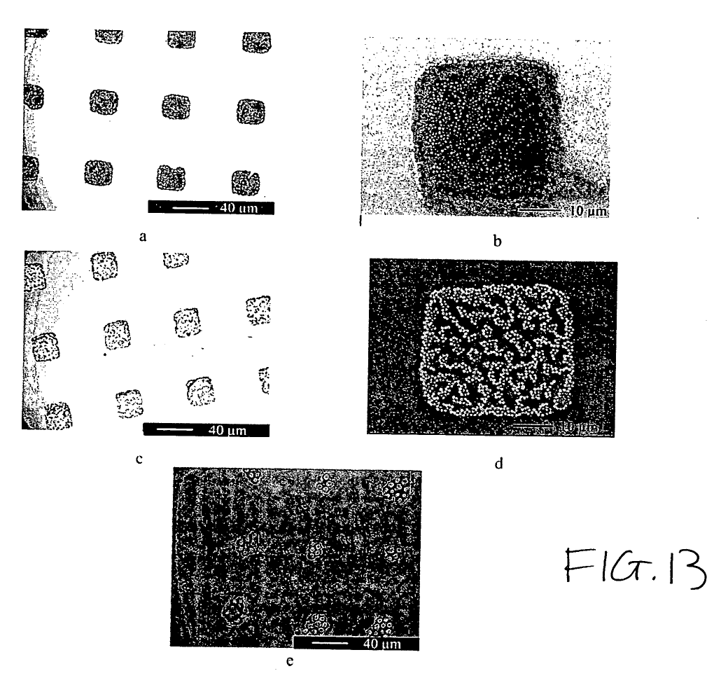

FIG. 17 shows a schematic of the pattern that was used to produce the images that were taken with an optical microscope and an atomic force microscope (AFM).

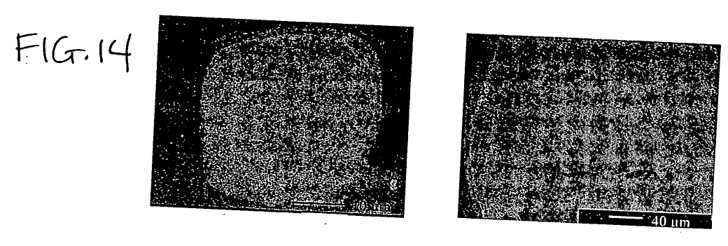

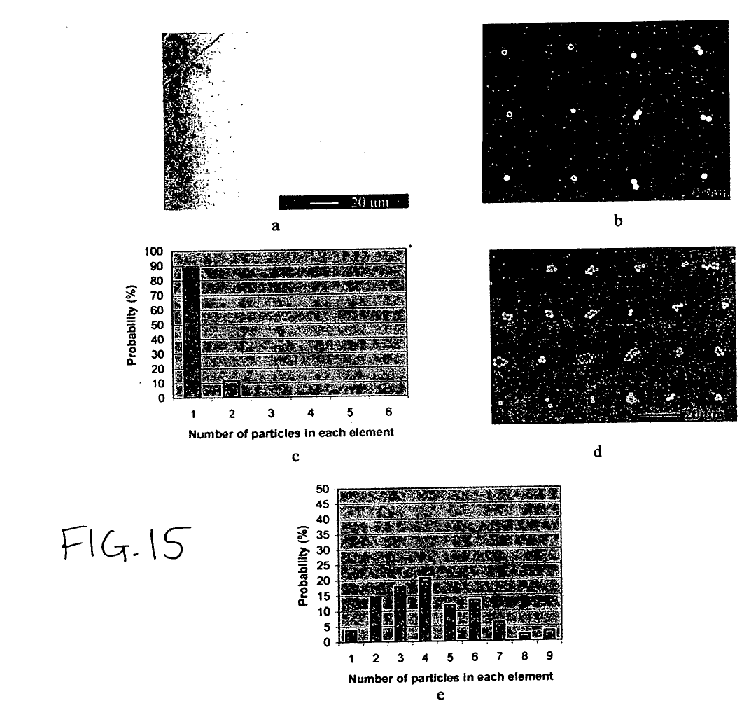

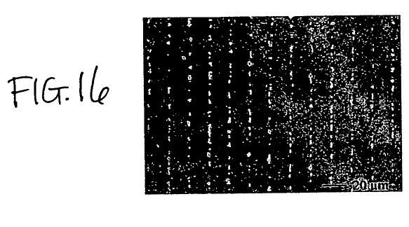

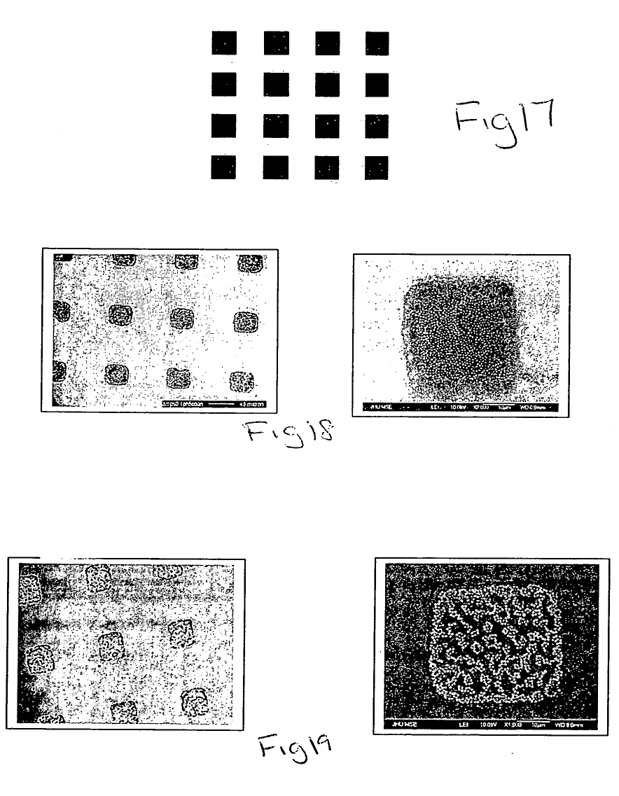

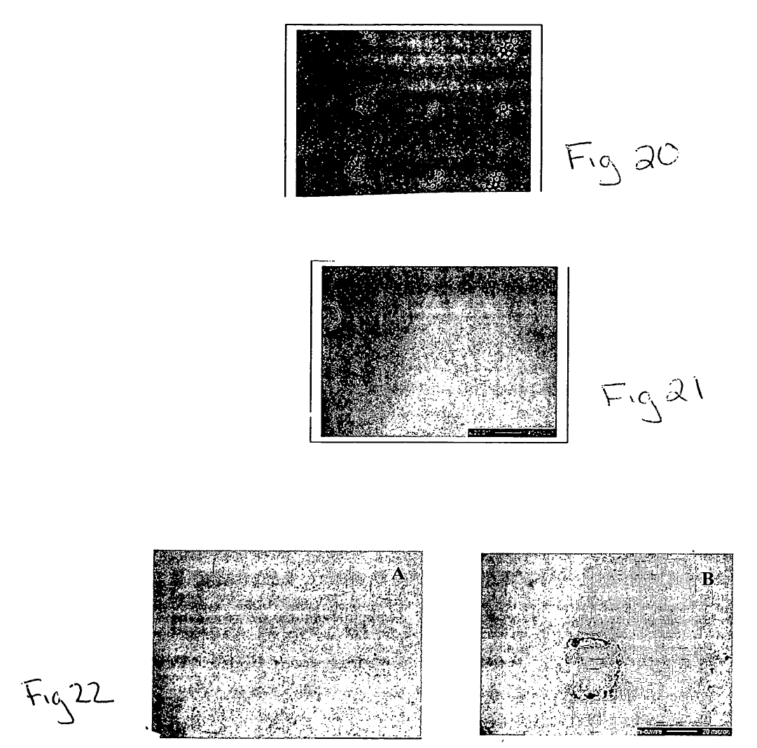

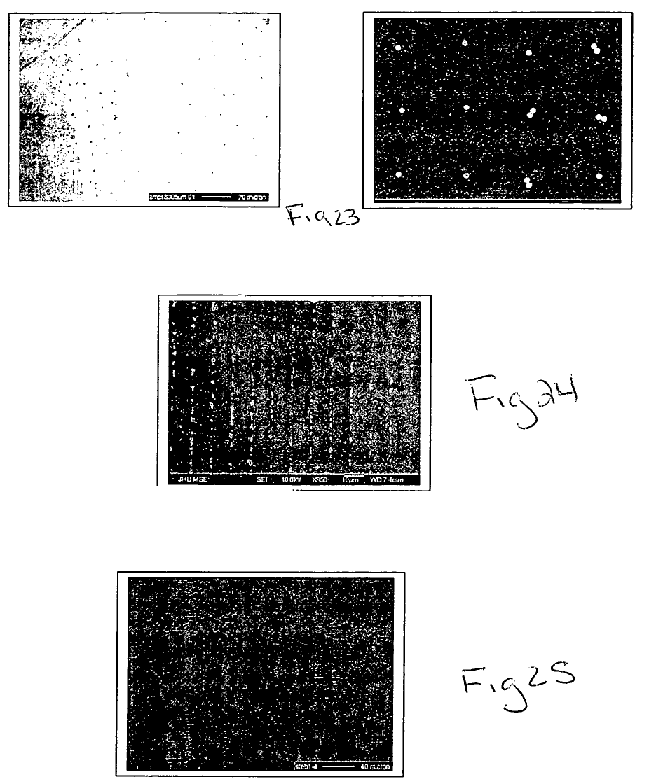

FIG. 18-27 show the fact that micro- or nano-meter scale objects deposit over the lyophilic regions by the dip-coating method. Thus, the latex, gold nanoparticles and nanowires are spatially distributed and arrayed into micro- or nano-meter scale geometries with periodicity on the larger areas by combining fluidic alignment with surface patterning techniques.

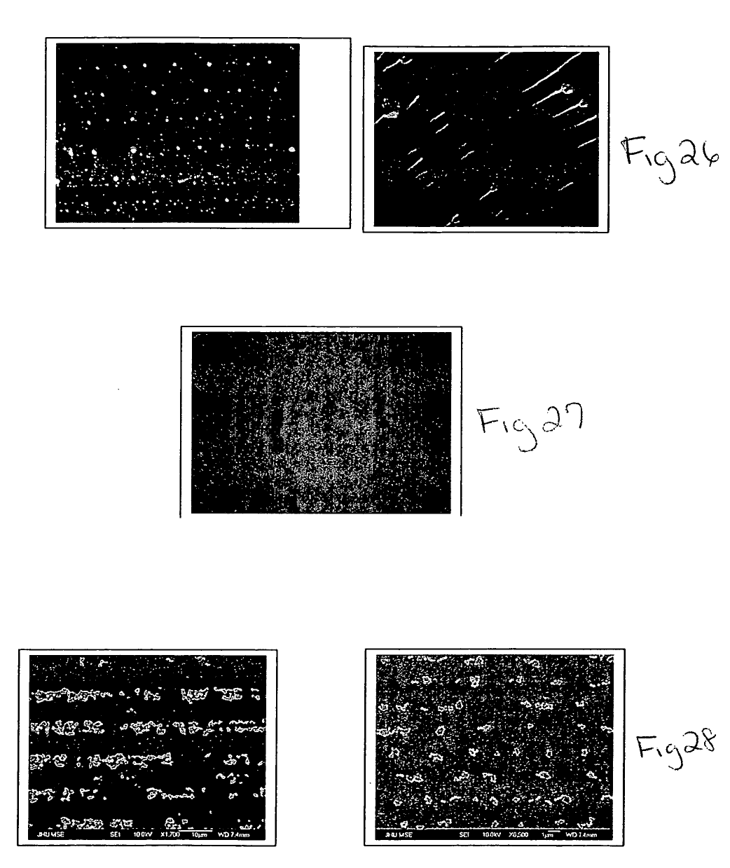

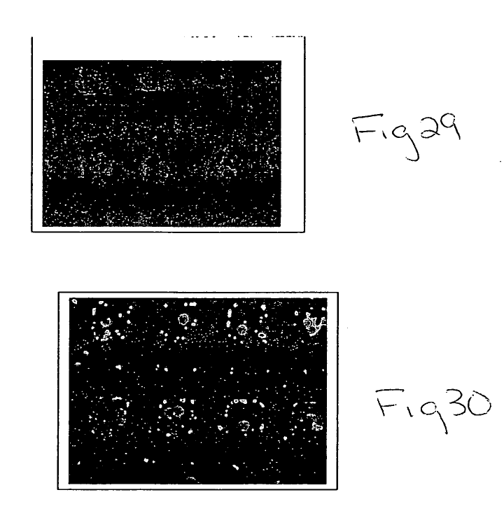

FIG. 28 demonstrate results that monodispersion particles can be separate from mixed suspension by adjusting the dimension of the hydrophilic pattern.

It was, thus, demonstrated that by making the dimensions of the lyophilic region(s) comparable to the particle size and by controlling the deposition conditions (i.e. evaporation rate, concentration of suspension), the deposited objects are limited by the dimension of the lyophilic region(s), thus creating assemblies.

### EXAMPLE 3

A sample was prepared by evaporating a drop of 0.01 wt % mixed suspension on surfaces with 1 μm lyophilic strips and 1 μm lyophobic strip apart at 25° C. and 26% humidity. The particles in suspension comprise a mixture of particles with diameters of 800 nm and 200 nm.

FIG. 3 shows optical microscopy images of shapes formed by the mixed particles with diameters of 800 nm and 200 nm, and magnification of some regions. The excellent selectivity of the particle deposition can be seen in the magnified images. As shown, all 800 nm particles go to the edge and accumulate locally after depinning and fast evaporation (FIG. 3c, d). The 200 nm particles deposit on lyophilic regions and mimic the parent pattern (FIG. 3b).

Consider a cylinder cap of radius R with a pinned contact line, created by a fluid wedge with contact angle θ. The height of the spherical cap h is determined simply by: tanθ/2=h/R. Here, the receding contact angle of surface with 1 μm strip is measured to be 40°, the height of kid drop is 200 nm. In this case, the 800 nm particles are larger than the feature height (200 nm) and, thus, were not deposited on the array, but rather, were convected backwards with the parent drop. The particles having diameters of 200 nm are near the height of the fluid element, and, thus, can be accommodated in the fluid element and deposited to discontinuous lines.

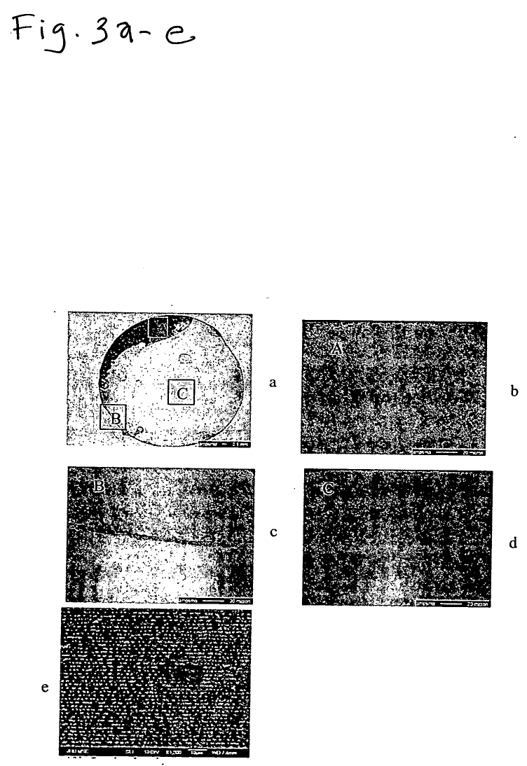

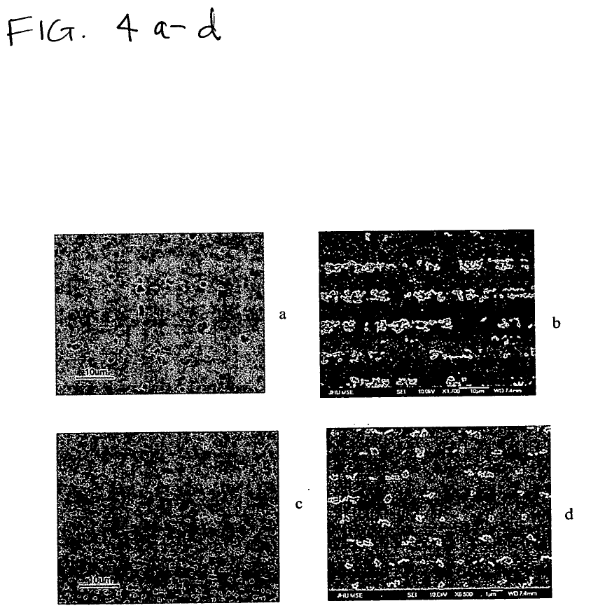

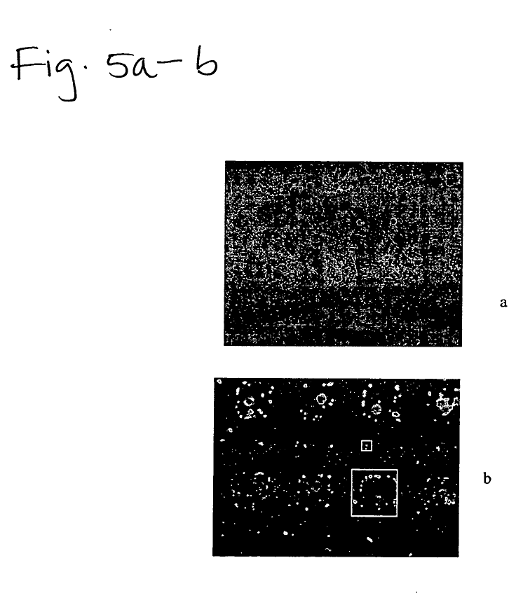

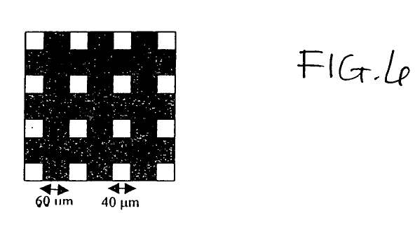

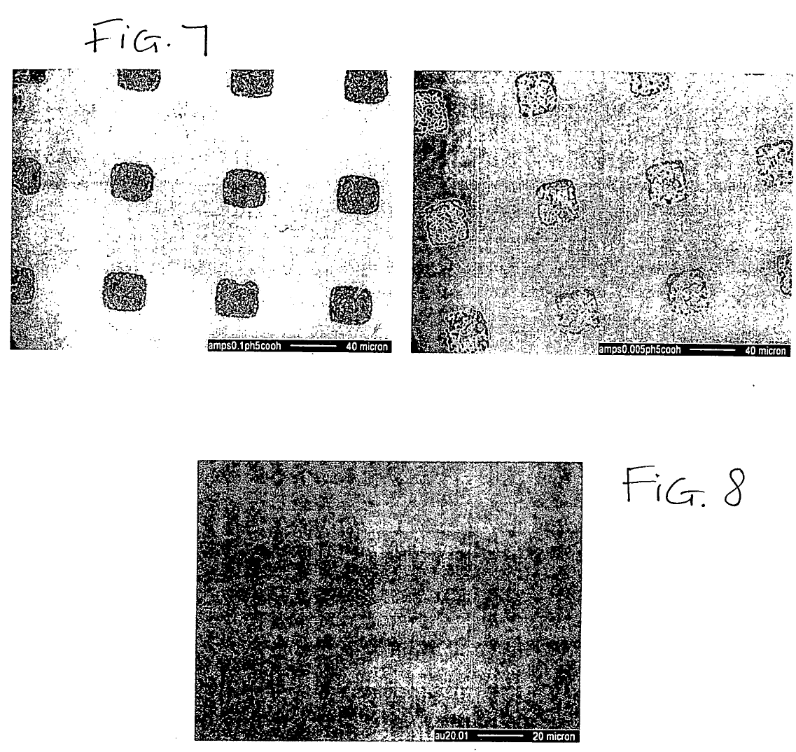

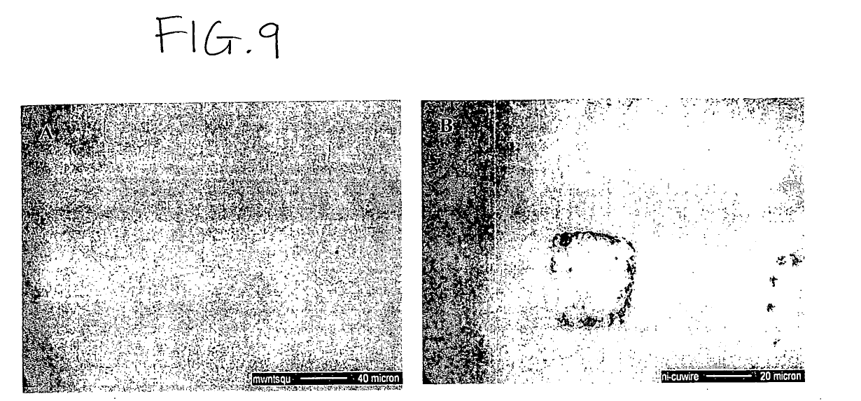

The same surface also was placed into the 0.01 v/w/o mixed suspension of 200 nm and 800 nm particles (1:1) and vertically lifted out of the suspension at a controlled slow speed. It is noted that the speed of withdrawal determines the thickness of the film deposited on the substrate. The rate of withdrawal, therefore, depends upon the desired film thickness and can be readily determined by one of skill in the art. In this example, the withdrawal rate was no slower than 0.1 micron/minute. The suspension specifically wets the lyophilic regions and induces the deposition of selective particles onto these areas as the contact lines sweep across the substrate surface. Only 200 nm particles deposit and array on the 1 μm strip pattern surface at a withdrawing speed of 10 μm/min, as shown in FIG. 4a. A mixture of particles are deposited on the lyophilic region by increasing the strip dimension to the width such that the cylinder cap height is comparable to the large particle diameter, i.e. 800 nm (FIG. 4b). The deposition was obtained by vertically lifting the substrate with a surface of 5 μm strip pattern at a withdrawing speed of 10 μm/min. The receding contact angle of the 5 μm strip pattern surface is 50°. This permits particles with a diameter of less than 1.1 μm deposit onto the surface. Those experimental results demonstrate that monodispersion particles can be separate from mixed suspension by adjusting the dimension of the lyophilic pattern. Similar results can be obtained from patterns parallel to the withdrawing direction and vertical to the withdrawing direction.

### EXAMPLE 4

Mechanisms similar to those used in Example 3 were used to direct the deposition of different size particle to form microchip structures. In FIG. 5a, 0.1% by volume suspensions of 0.9 μm and 2 μm spheres (1:3) were deposited onto a patterned surface with alternative lines of 5 μm lyophilic patches and 25 μm lyophilic squares to form arrays of small colloidal particles on the 5 μm lyophilic patches and with mixtures of colloidal particles on the 25 μm lyophilic patches.

These results are of particular interest in biosensors when different proteins or other biologically based materials are to be attached onto the different patches. To demonstrate this concept, two sizes of streptavidin-functionalized microspheres were further bounded by exposing the microspheres to two different solutions of fluorescein-biotin. The small particles, of diameter 0.9 microns, were exposed to fluorescein-biotin that fluoresces green when exposed to light of wavelength 495 nm. The larger particles, of diametr 5 microns, were exposed to fluorescein biotin that fluoresces red when exposed to light of wavelength 594 nm. These excitation wavelengths are determined by the molecular structure of the particular fluorescein dye attached to the biotin. Prior to immersing the particles in these fluorescein-biotin solutions, the sample was exposed to both light of 495 nm and light of 594 nm. No fluorescence was observed. After functionalizing in the green-fluorescent fluorescein-biotin solution, all of the patterns fluoresce green when excited at the appropriate wavelength confirming that small particles deposit on all of the patterns (FIG. 5b) and form coffee ring structure on large pattern regions. After functionalizing in the red-fluorescent fluorescein-biotin solution, red fluorescence was only observed on large patterned regions for 5 μm streptavidin-functionalized microspheres.

### EXAMPLE 5

Substrates were prepared from silicon wafers (Montco Silicon Technologies, Inc.) coated with 1-3 nm of chromium and 100 nm of gold. Patterned self-assembled monolayers (SAMs) were formed using microcontact printing, for example, as described in detail in A. Kumar, G. M. Whitesides, Appl. Phys. Lett. 1993, 58, 1200. In general, elastomeric polydimethylsiloxane (PDMS) stamps with various microstructures were inked with a 1 mM solution of HS(CH₂)₁₅COOH in ethanol, brought into contact with the gold surface for 1 min, and rinsed with ethanol to produce discrete domains covered with a carboxylic acid terminated SAM on the substrate. The substrates were subsequently immersed in a 1 mM solution of HS(CH₂)₁₇CH₃ in ethanol for 1 hour to cover the remainder of the surface with a methyl-terminated SAM. Suspensions of particles (Interfacial Dynamics) of various volume fractions were made in water of pH 2 (adjusted by the addition of HCl) in order to prevent disassociation of the carboxylic acid headgroup on the patterned SAM. A homogeneous SAM of HS(CH₂)₁₅COOH has an advancing contact angle of 31° with water at pH 2; a homogeneous SAM of HS(CH₂)₁₇CH₃ has an advancing contact angle of 103° with water at pH 2.

Polystyrene spheres (Interfacial Dynamics, Corp.) with a range of diameters from 200 nm to 10 μm were suspended in distilled water of pH 2 over volume fractions ranging from 1% to 10-4%. Some of the particles were functionalized with positively charged amidine groups, others with negatively charged sulfate groups. Surface functionalization renders the polystyrene spheres lyophilic, allowing them to be dispersed in water. Identical results for the particles of diameter 0.8 μm were obtained with both amidine and sulfate functionalized microspheres. The particular functionalization for each particle used in any given experiment is reported in Table 1 along with the nominal charge/particle.

TABLE 1
Properties of Particles Used in Experiments

| | Surface | | |
|---|---|---|---|
| | functionalized | | Charges/ |
| Diameter of Particle | group | Charge | particle* |
| 10 μm | Sulfate | − | N/A |
| 1.2 μm | Amidine | + | 3.1 × 10⁶ |
| 0.8 μm | Amidine | + | 2.45 × 10⁶ |
| 0.8 μm | Sulfate | − | 7.8 × 10⁵ |
| 200 nm | Amadine | + | 6.8 × 10⁴ |
| 40 nm Au | Au | none | none |

*as reported by the manufacturer

Suspensions of 40 nm diameter gold nanoparticles (Ted Pella, Inc.), suspended in water of pH 5-6, were also studied at volumes fractions of 0.01-0.0001%. Because these particles are not charged, the pH was not adjusted to prevent disassociation of the carboxylic acid headgroup. In each experiment, a 100 μL drop containing suspended particles was deposited on the patterned surfaces. All experiments were performed at 20% relative humidity and at 25° C. unless otherwise noted. For these conditions and for drops of the radii studied, the drop evaporated completely in roughly 6 hours. The structures formed by the dried particles were investigated with an optical microscope and scanning electron microscope after the drop had evaporated. Each deposition experiment was repeated three times. The surface tension of the suspensions was monitored by the pendant drop method for 50 min for each suspending system to confirm that the suspension of particles was surfactant-free.

Results:

It is noted that the results described in this work do not depend on electrostatic interactions.

When a drop was placed on substrates patterned with square features, it spread to attain some initial diameter. The contact line remained fixed for some period of time, after which it began to recede. If a sessile drop profile was recorded, and the contact angle was inferred from apparent angle of the fluid wedge as determined from a drop silhouette, the contact angle evolution looked much like that of a drop on an energetically homogeneous substrate, as reported in FIG. 11 for a surface with 50 μm lyophilic squares spaced 50 μm apart. The initial contact angle was high (an apparent advancing contact angle). During the time that the contact line remained fixed, the contact angle decreased to some value (an apparent receding contact angle), after which the drop receded with a fixed angle. These apparent angles depend on the underlying pattern and are bounded by the contact angles of the pure carboxylic terminated or methyl-terminated SAMs. The apparent receding contact angles for two patterns (50 μm squares spaced by 50 μm, and 5 μm squares spaced by 5 μm) are reported in Table 2.

TABLE 2
Receding Contact Angloe and Particles Excluded from Patterns

| | Apparent | | |
|---|---|---|---|
| | receding | Cap height | Heights of |
| | contact | calculated | particles |
| Patterned surface | angle (deg) | (μm) | excluded (μm) |
| 50 μm square lyophilic | 60 | 14.4 | none |
| features spaced 50 μm | | | |
| apart | | | |
| 5 μm square lyophilic | 30-50 | 1.14 | 1.2, 1.6, 2 |
| features spaced 5 μm | | | |
| apart | | | |

The contact line dynamics were complex, exhibiting two dimensional (2-D) percolation. When the receding contact line encountered a lyophihc feature, it became pinned at the lyophilic/lyophobic (“wet”/“non-wet”) edges but pulled back from the lyophoboic domains. These local dynamics caused liquid to flow out of the lyophobic regions and into the lyophilic regions, as shown in FIG. 12. In FIG. 12a, an optical image of the receding contact line of the droplet is shown on a SAM of 50 μm square lyophilic features spaced 50 μm apart. The dynamics of this contact line were also recorded by video. The bright regions are relatively free of liquid, the large dark region is the drop, and the corrugated edge was created by the flow out of the lyophobic regions into the lyophilic features. As each lyophilic domain filled with fluid, the contact line depinned from that site and jumped backward from the feature, tearing off to form a discrete fluid element in the lyophilic patch (see schematic in FIG. 12b). Since each element does not fill at the same time, different segments of the contact line jump at different times, so the recession of this line is characterized by a series of depinning events, and the geometry of the corrugated edge varies as it jumps from one pinning feature to another, always in the direction of the receding parent drop.

Without being bound by theory, it is believed that the height of the fluid element formed was determined by the apparent receding contact angle of the drop. When the height of the fluid element was larger than the diameter of the particle to be placed on it, particles could be accommodated in the fluid element and organized by the flow field within the element. When particles were larger than the fluid element height, they were excluded from the fluid element and were pulled backward with the parent drop.

Consider a cylinder cap of radius R with a pinned contact line, created by a fluid wedge with contact angle θ. The height of the spherical cap h is determined by Equation 1 set out above:

$$tan \frac{θ}{2} = \frac{h}{R}$$

Generalizing this argument to a feature of characteristic length scale R, the height of the fluid elements varies with the contact angle, and with the length scale of the feature itself. In Table 2, results from a series of experiments are summarized in which suspensions of particles with differing diameters were evaporated on substrates patterned with 5 μm squares. Particles larger than the feature height as inferred from Equation 1 were not deposited on the array, but were convected backward with the parent drop. If the particle diameters were less than the height of the fluid element, they were accommodated in the fluid element and deposited in patterns influenced by the flow within the lyophilic feature. Because all of the particles used in the deposition experiments were smaller than the inferred height of the fluid element on the 50 μm square features, particles were deposited consistently on the lyophilic domains of this length scale.

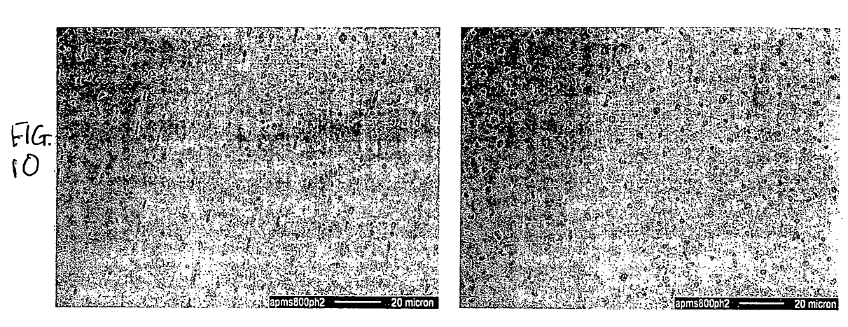

Results for micrometer-sized particles deposited on a surface pattered with 50 μm squares are presented in FIG. 13. As the fluid element evaporated, its contact line was pinned as its contact angle evolved from its initial value to the receding contact angle on the lyophilic region itself. Depending upon the volume fraction, the flow within the element can organize the suspended particles within it. At high volume fractions, the particles pack to form dense multilayers and are not influenced by convection within the feature. In FIG. 13a, 0.1 vol % suspensions of 0.8 μm spheres deposited to form a regular array of colloidal particles on the lyophilic patches, with the lyophobic regions being nearly free of particles. In FIG. 13b, a scanning electron microscopy (SEM) image reveals particles packed in highly ordered multilayers, with a monolayer on the border. In FIG. 13c-d, optical and SEM images show that a more dilute suspension (0.01 vol %) of the same microspheres form an ordered incomplete monolayer. The edges of these patterns are more densely packed monolayers, with a “coffee-ring” of particles formed by convection to the pinned contact line. When the particles are just less than the feature height and lateral dimension, only a few particles are retained in each feature, as shown in FIG. 13e, where clusters of 10 μm particles (0.07 vol %) formed on each feature.

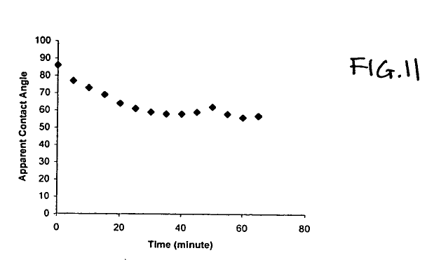

These surfaces were also used to deposit particles with diameters on the nanometer length scale. When 200 nm particles are deposited on 50 μm squares, similar arrangements of particles formed (images not shown). In FIG. 14a, SEM images of patterns formed by 40 nm gold particles (0.01 vol % s) deposited on these substrates formed a multilayer filling the feature. In FIG. 14b, a more dilute suspension of the same particles (0.0001 vol %) deposited primarily at the edges of the feature to form a “coffee ring”. In FIG. 15a-b, results obtained with suspensions of 0.8 μm particles (0.01 vol %) on 5 μm squares are shown. Each feature contained only one or two particles. In FIG. 15c, a histogram of the particle distribution over 100 features is shown, with a preponderance of the features containing only a single particle. It is noted that these results are very sensitive to variations in laboratory conditions. Distributions of particles under apparently similar conditions can differ strongly, as shown in the figure and histogram of FIG. 15d-e. These results demonstrate that under appropriate conditions, lattices of single particles can form but that subtle differences in laboratory conditions can strongly alter the patterns.

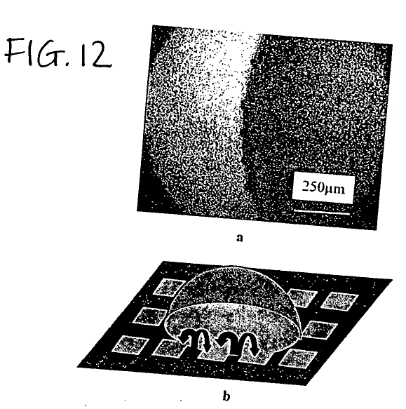

Other surface patterns were also studied. When a striped patterned surface was used, with alternating lyophilic stripes (5 μm wide) and lyophobic stripes (5 μm wide), discontinuous lines of the 0.8 μm particles formed in a manner that mimics the lyophilic patterns of the substrate, as shown in FIG. 16.

All documents mentioned herein are incorporated by reference herein in their entirety.

The foregoing description of the invention is merely illustrative thereof, and it is understood that variations and modifications can be effected without departing from the scope or spirit of the invention as set forth in the following claims.

1. A method for depositing and/or sorting microscale, nanoscale and molecular scale objects onto a surface comprising utilizing a combination of fluidic alignment and surface patterning techniques whereby the surface is modified to have a pattern formed thereon and fluidic alignment is performed to deposit the objects onto the patterned surface.

2. A method for depositing and/or sorting microscale, nanoscale and molecular scale objects onto a surface comprising forming a pattern on the surface, depositing a fluid suspension of the objects onto the patterned surface, and selectively removing the solvent in the fluid element to deposit and/or sort the objects onto the patterned surface.

3. A method for sorting microscale, nanoscale and molecular scale objects by size onto a surface comprising forming a pattern with features of differing dimension on the surface, depositing a fluid suspension of the objects to be sorted by dimension onto the patterned surface, and selectively removing the solvent in the fluid element to deposit the objects and sort them according to size onto the patterned surface.

4. A method for depositing and/or sorting microscale, nanoscale and molecular scale objects onto a surface comprising:
obtaining the surface;
creating a lyophilic pattern on the surface;
depositing a fluidic suspension containing the microscale, nanascale and/or molecular scale objects onto the surface; and
allowing the solvent to be selectively removed thereby depositing and/or sorting the microscale, nanoscale and/or molecular scale objects onto the surface.

5. A method for depositing and/or sorting microscale, nanoscale and molecular scale objects onto a surface comprising utilizing surfaces of patterned lyophilic and lyophobic regions to provide a template to deposit the objects by selectively removing the solvent in the fluid element from a drop or a dip-coated thin film, or a continuously deposited and evaporated film.

6. The method of claim 2, wherein the step of selectively removing the solvent in the fluid element comprises evaporating the fluid.

7. The method of claim 2, wherein the step of selectively removing the solvent in the fluid element comprises allowing the surface to absorb or otherwise incorporate the solvent.

8. The method of claim 2, wherein the step of selectively removing the solvent in the fluid element comprises removing the solvent by suction.

9. The method of claim 1, wherein fluidic alignment comprises depositing a suspension of the objects on the surface and selectively removing fluid from the suspension.

10. The method of claim 9, wherein the step of selectively removing fluid from the suspension comprises evaporating the fluid.

11. The method of claim 9, wherein the step of selectively removing fluid from the suspension comprises allowing the surface to absorb or otherwise incorporate the solvent.

12. The method of claim 9, wherein the step of selectively removing fluid from the suspension comprises removing the solvent by suction.

13. The method of claim 1, wherein the microscale, nanoscale and molecular scale objects are selected from any objects that are capable of suspension in a solvent or that may be modified to be capable of suspension in a solvent.

14. The method of claim 13, further comprising:
surface functionalizing the object so that it is capable of suspension in a solvent.

15. The method of claim 14, wherein surface functionalizing is accomplished by adding surfactants that adsorb or bind to the particle surface, or by adding dyes or biomolecules.

16. The method of claim 13, further comprising:
appending the object with chemical moieties to form new molecules capable of suspension in a solvent.

17. The method of claim 1, wherein the microscale, nanoscale and molecular scale objects are selected from metallic materials, magnetic materials, inorganic materials, polymeric materials, biological materials, small molecules, solutes of molecular dimensions, and composite materials made therefrom.

18-49. (canceled)

50. A two-dimensional array of micro and/or nanoscale objects fabricated in accordance with the claim 1.

51. Arrays for biosensors fabricated in accordance with the claim 1.

52. Microphotonics products fabricated in accordance with the claim 1.

53-54. (canceled)
